(19) United States
(12) Patent Application Publication
(10) Pub. No.: US 2020/0363755 A1
(43) Pub. Date: Nov. 19, 2020

(54) DEVELOPING DEVICE

(71) Applicant: CANON KABUSHIKI KAISHA, Tokyo (JP)

(72) Inventors: Takehiro Kishi, Toride-shi (JP); Teppei Nagata, Abiko-shi (JP); Hiroki Sato, Tsukubamirai-shi (JP)

(21) Appl. No.: 16/986,460

(22) Filed: Aug. 6, 2020

Related U.S. Application Data
(63) Continuation of application No. PCT/JP2019/012286, filed on Mar. 15, 2019.

(30) Foreign Application Priority Data
Mar. 16, 2018 (JP) 2018-049640

(51) Int. Cl. G03G 15/10

(52) U.S. Cl. CPC G03G 15/105; G03G 15/101; G03G 15/108

(57) ABSTRACT

In a developer receiving portion 45, a receiving port 51 for receiving a liquid developer and a discharging port 57 for permitting discharge of the received liquid developer. A film forming electrode 44 is provided opposed to a developing roller 41 with a predetermined gap G and forms a film, on a surface of the developing roller 41, of the liquid developer supplied to the predetermined gap G through the discharging port 57. Further, the developer receiving portion 45 includes a partition plate 47 which partitions an inside space 45a, filled with the liquid developer supplied through the receiving port 51, into a first chamber 61 on the receiving port 51 side and a second chamber 62 on the discharging port 57 side. The partition plate 47 is provided with a plurality of communication ports 50 formed with respect to a liquid developer so as to communicate the first chamber 61 and the second chamber 62 with each other.

### TECHNICAL FIELD

The present invention relates to a developing device using a liquid developer containing toner and a carrier liquid.

### BACKGROUND ART

As an image forming apparatus, a constitution in which an image is formed by using the liquid developer containing the toner and the carrier liquid has been known. A developing device used in such an image forming apparatus includes a developer receiving portion foe receiving the liquid developer, a developing roller for developing an electrostatic latent image formed on a photosensitive member, and a film forming electrode for forming a film of the liquid developer on the developing roller.

As such a developing device, a constitution in which the liquid developer supplied to a predetermined gap is rectified by narrowing a flow passage from a receiving port (opening) for receiving the liquid developer of the developer receiving portion to a discharging port (opening) for permitting supply of the liquid developer to the predetermined gap has been proposed (Japanese Patent No. 6042967).

### Problem to be Solved by the Invention

In the case of the developing device using the liquid developer as described above, a flow of the liquid developer flowing in the developer receiving portion through the receiving port is disturbed, and therefore, in the case where the liquid developer is intended to be supplied to the predetermined gap in a state in which the flow of the liquid developer is still disturbed, a flow rate distribution of the liquid developer is liable to become non-uniform with respect to a longitudinal direction of the developing roller. Then, when the liquid developer is supplied to the predetermined gap in a state in which the flow rate distribution is still non-uniform, an amount of the developer formed in a film on the developing roller becomes non-uniform, i.e., there is possibility that improper coating occurs.

On the other hand, in the case of the constitution disclosed in the Japanese Patent No. 6042967, the liquid developer is rectified by narrowing the flow passage of the developer receiving portion, and therefore, there is a need to make the flow passage long, and as a result thereof, the developing device is upsized.

### Object of the Invention

The present invention aims to provide a constitution realizing downsizing of a developing device while suppressing an occurrence of improper coating.

### Means for Solving the Problem

According to an aspect of the present invention, there is provided a developing device comprising: a developer carrying member rotatable while carrying liquid developer containing toner and a carrier; an accommodating member which includes a receiving port for receiving the liquid developer and a supplying port for supplying the received liquid developer to the developer carrying member and which accommodates the liquid developer; and a partitioning member extending over a rotational axis direction of the developer carrying member and partitioning an inside space of the accommodating member into a first chamber including the receiving port and a second chamber including the supplying port, wherein in the partitioning member, a plurality of communication ports for communicating between the first chamber and the second chamber are formed over the rotational axis direction of the developer carrying member.

### Effect of the Invention

According to the present invention, it is possible to realize the downsizing of the developing device while suppressing the occurrence of the improper coating.

### BRIEF DESCRIPTION OF THE DRAWINGS

FIG. 1 is a schematic structural sectional view of an image forming apparatus according to a first embodiment.

FIG. 2 is a schematic view showing a circulation path of a liquid developer at a periphery of a developing device according to the first embodiment.

FIG. 3 is a schematic structural sectional vie of the developing device according to the first embodiment.

In FIG. 4, par (a) is a schematic structural sectional view of the developing device according to the first embodiment cut in a longitudinal direction, and part (b) is a view showing a flow rate distribution, with respect to the longitudinal direction, of the liquid developer supplied from a first chamber to a second chamber of the developing device according to the first embodiment.

In FIG. 5, part (a) is a schematic structural sectional view of a developing device according to a comparison example cut in the longitudinal direction, and part (b) is a view showing a flow rate distribution, with respect to the longitudinal direction, of the liquid developer supplied from a first chamber to a second chamber of the developing device according to the comparison example.

FIG. 6 is a schematic structural sectional view showing a developer receiving portion and a part of a film forming electrode according to the first embodiment.

In FIG. 7, part (a) is a schematic structural sectional view of a developing device according to a second embodiment cut in a longitudinal direction, and part (b) is a view showing a flow rate distribution, with respect to the longitudinal direction, of the liquid developer supplied from a first chamber to a second chamber according to the second embodiment.

### EMBODIMENTS FOR CARRYING OUT THE INVENTION

### First Embodiment

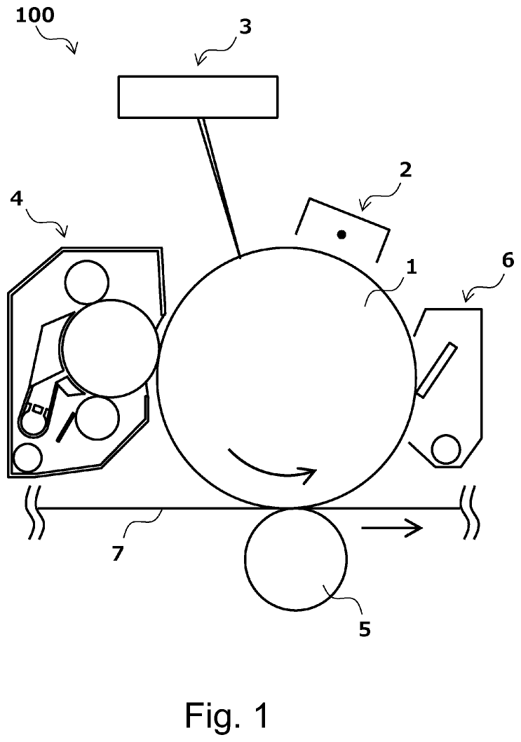

A first embodiment will be described using FIG. 1 to FIG. 6. First, a schematic structure of an image forming apparatus of this embodiment will be described using FIG. 1.

### [Image Forming Apparatus]

For example, an image forming apparatus 100 is a full-color printer of an electrophotographic type in which four image forming portions provided corresponding to four colors of yellow (Y), magenta (M), cyan (C) and black (K). In this embodiment, the image forming apparatus 100 is of a tandem type in which the image forming portions are disposed along a rotational direction of an intermediary transfer belt 7 described later. The image forming apparatus 100 forms a toner image on a recording material depending on an image signal from an external device communicatably connected with an image forming apparatus main assembly, for example. As the recording material, a sheet material such as a sheet, a plastic film, a cloth or the like is cited.

The image forming portions form, on photosensitive drums 1 as image bearing members (on the image bearing members), toner images of the respective colors by using liquid developers each containing toner and a carrier liquid. Incidentally, the respective image forming portions have the substantially same constitution except that development colors are different from each other. For this reason, in FIG. 1, only one image forming portion of a plurality of image forming portions possessed by the image forming apparatus 100 is shown.

The photosensitive drum 1 is a cylindrical photosensitive member and is rotated in an arrow direction in the figure. At a periphery of the photosensitive drum 1, along a rotational direction of the photosensitive drum 1, a charging device 4, an exposure device 3, a developing device 4, a transfer roller 5 and a cleaning device 6 are provided in this order. The photosensitive drum 1 is surface-charged uniformly by the charging device 2 and an electrostatic latent image is formed on the surface of the photosensitive drum 1 by the exposure device 3 driven on the basis of a transmitted image signal. The electrostatic latent image on the photosensitive drum 1 is developed as a toner image by the developing device 4.

The toner image developed from the electrostatic latent image is transferred onto the intermediary transfer belt which is an endless belt provided below the photosensitive drum 1. At this time, at primary transfer portions each formed by the photosensitive drum 1 and the transfer roller 5 each of the image forming portions, the toner images on the photosensitive drums 1 are superposedly transferred.

On the other hand, the recording material fed from an unshown feeding device is fed to a nip between an unshown secondary transfer roller and the intermediary transfer belt 7. Then, in the nip, a predetermined pressing force and an electrostatic load bias are imparted, so that the toner image on the intermediary transfer belt 7 is transferred onto the recording material. Thereafter, the recording material is fed to an unshown fixing device, and the toner image is fixed on the recording material by the fixing device. The liquid developer containing transfer residual toner remaining on the photosensitive drum 1 after the transfer is collected by the cleaning device 6.

### [Circulation Path of Liquid Developer Around Developing Device]

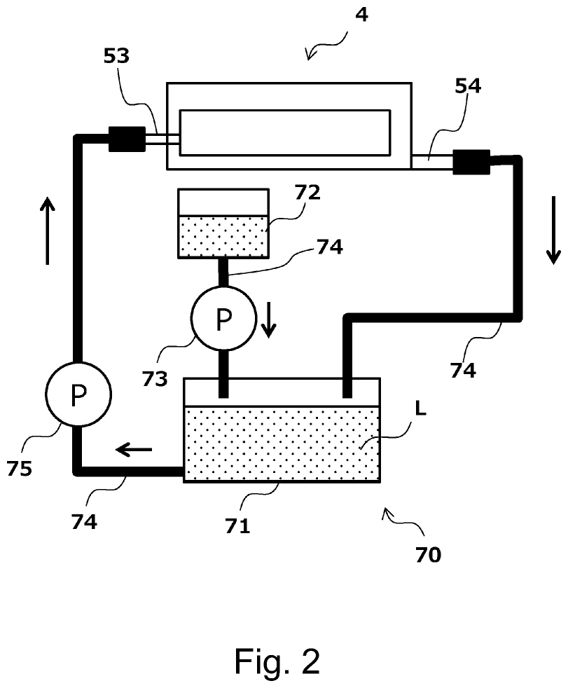

Next, a circulation path of the liquid developer around the developing device will be described using FIG. 2. The developing device 4 is supplied with a liquid developer L in which toner particles are dispersed in a carrier liquid, and further, a part of the supplied liquid developer L is discharged therefrom. For this reason, the liquid developer L is circulated between a tank 71 and the developing device 4 by a supplying mechanism 70.

The supplying mechanism 70 includes the tank 71, a replenishing tank 72, a replenishing pump 73, a feeding hose 74, a supplying pump 75 and the like. The supplying pump 75 supplies and feeds the liquid developer L in the tank 71 to the developing device 4. The liquid developer L discharged from the developing device 4 is collected and fed to the tank 71. Incidentally, the tank 71, the supplying pump 75 and the developing device 4 are connected by the feeding hose 74.

Inside the tank 71, the liquid developer L is stored. At a periphery of the tank 71, the replenishing tank 72 is disposed, and depending on a toner consumption amount, replenishing of the toner and the carrier liquid is carried out from the replenishing tank 72 to the tank 71 by the replenishing pump 73. By this, the liquid developer with a predetermined toner content (proportion between the toner and the carrier liquid) can be supplied to the developing device 4.

### [Developing Device]

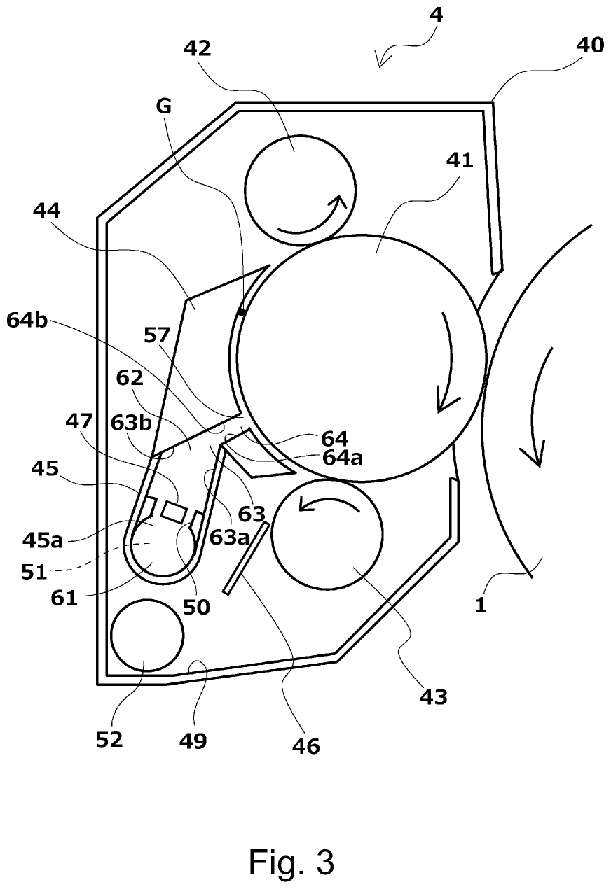

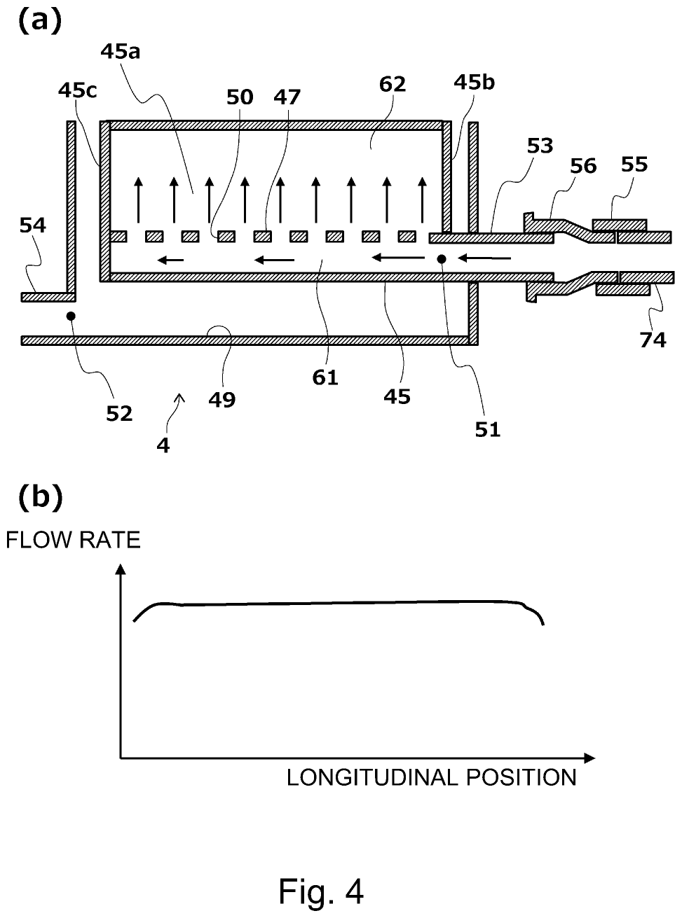

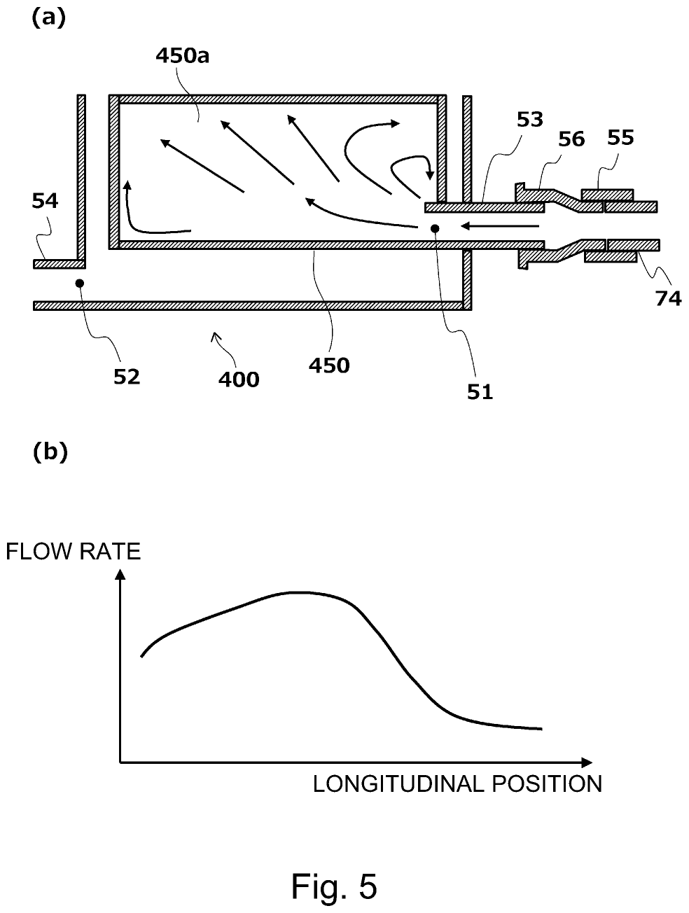

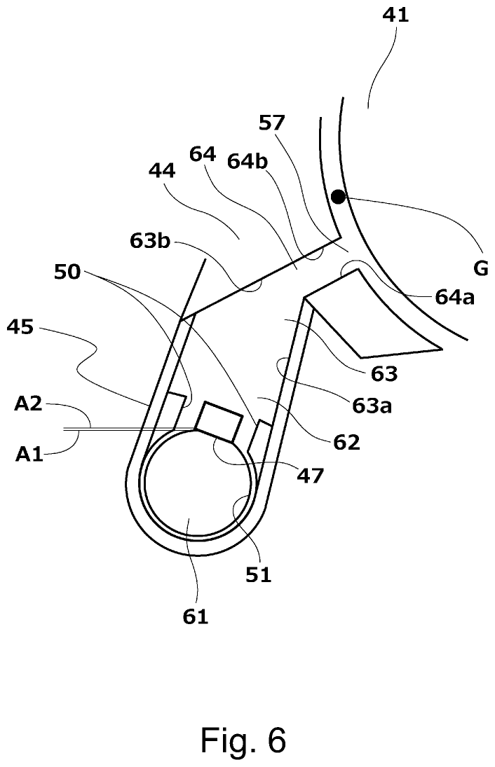

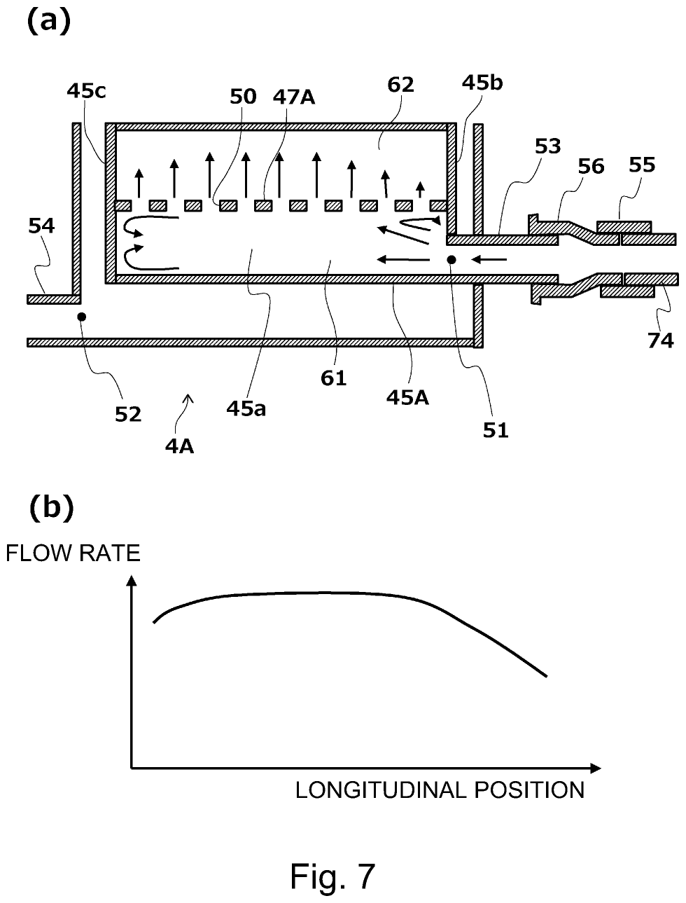

Next, a structure and an operation of the developing device 4 will be described using FIG. 3 and parts (a) and (b) of FIG. 4. The developing device 4 is constituted as shown in FIG. 3 by a casing 40, a developing roller 41, a squeeze roller 42, a cleaning roller 43, a film forming electrode 44, a developer receiving portion (opening) 45 and the like. The developing roller 41, the squeeze roller 42, the cleaning roller 43, the film forming electrode 44 and the developer receiving portion 45 are disposed in the casing 40. The casing 40 is open at a portion opposing the photosensitive drum 1, and a part of the developing roller 41 is exposed from this portion.

The developing roller 41 rotates while carrying the liquid developer. Further, the developing roller 41 contacts the photosensitive drum 1 through an opening (portion) of the casing 40, and visualizes the electrostatic latent image on the photosensitive drum 1 into the image by the carried liquid developer.

At the developer receiving portion 45, a receiving port (opening) 51 for receiving the liquid developer and a discharging port (opening) 57 for permitting discharges of the received liquid developer are formed. Such a developer receiving portion 45 receives the liquid developer, supplied from an external tank 71, through the receiving port 51 and stores the liquid developer in an inside space 45, and supplies the liquid developer through the discharging port 57 to a predetermined gap G between the developing roller 41 and the film forming electrode 44.

That is, as shown in part (a) of FIG. 4, to one longitudinal direction end portion (widthwise direction one end portion) at a lower portion of the developer receiving portion 45, a supplying pipe 53 is connected. Further, an opening on the inside space 45a side of the supplying pipe 53 is the receiving port 51. Accordingly, the receiving port 51 is formed at the longitudinal direction one end portion of the developer receiving portion 45.

Further, the receiving port 51 is formed so that an inflow direction of the liquid developer flowing through the receiving port 51 is substantially parallel to the longitudinal direction. That is, the supplying pipe 53 is connected to the developer receiving portion 45 in a state in which the supplying pipe 53 is disposed substantially in parallel to the longitudinal direction, and therefore, through the receiving port 51 which is an opening of the supplying pipe 53 on the inside space 45a side, the liquid developer flows substantially in parallel to the longitudinal direction.

The supplying pipe 53 is connected to the feeding hose 74 by connecting members 55 and 56. For this reason, the liquid developer in the tank 71 is supplied to the receiving port 51 through the feeding hose 74 and the supplying pipe 53 by the supplying pump 75. Then, the liquid developer received through the receiving port 51 inside the inside space 45a of the developer receiving portion 45 is discharged through the discharging port 57. The discharging port 57 opens to the predetermined gap G described below, and therefore, the liquid developer discharged through the discharging port 57 is supplied to the predetermined gap G. Incidentally, a structure of the developer receiving portion 45 in the inside space 45a will be described later.

The film forming electrode 44 is disposed opposed to the developing roller 41 through the predetermined gap G and forms, in a film on the surface of the developing roller 41, the liquid developer supplied to the predetermined gap through the discharging port 57 of the developer receiving portion 45. That is, the liquid developer supplied through the discharging port 57 is scooped into the predetermined gap G between the developing roller 41 and the film forming electrode 44 by rotation of the developing roller 41. A potential difference is provided between the developing roller 41 and the film forming electrode 44, and the toner in the liquid developer is attracted to the surface of the developing roller 41 and is carried on the developing roller 41.

The squeeze roller 42 is disposed downstream of the film forming electrode 44 with respect to the rotational direction of the developing roller 41 and forms a nip in contact with the developing roller 41. For this reason, the liquid developer carried on the developing roller 41 and passed through an opposing region to the film forming electrode 44 thereafter reaches the nip between the squeeze roller 42 and the developing roller 41. Then, in the nip, a part of the liquid developer on the surface of the developing roller 41 passes, and a remaining liquid developer passes through a back-surface side of the film forming electrode 44 and falls on a bottom 49 of the casing 40.

On the other hand, the liquid developer carried on the developing roller 41 and passed through the nip with the squeeze roller 42 is fed to the nip (developing portion) between the developing roller 41 and the photosensitive drum 1, and develops the latent image on the photosensitive drum 1.

The cleaning roller 43 is disposed downstream of the developing portion with respect to the rotational direction of the developing roller 41 and forms a nip in contact with the developing roller 41. For this reason, the liquid developer passed through the developing portion and remaining on the developing roller 41 is collected by the cleaning roller 43 by using an electrostatic force. The liquid developer on the cleaning roller 43 is scraped off by a cleaning blade 46 and falls on the bottom 49 of the casing 40.

Here, a liquid amount of the liquid developer supplied to the developer receiving portion 45 from the tank 71 is set so as to be larger than an amount of the liquid developer scooped up to the predetermined gap G between the developing roller 41 and the film forming electrode 44. By this, a lowering in liquid surface in the developer receiving portion 45 is prevented. That is, the inside space of the developer receiving portion 45 is in a state in which the inside space is filled with the liquid developer supplied from the tank 71 by the supplying pump 75 (FIG. 2).

Of the liquid developer supplied to the inside space of the developer receiving portion 45, an excessive liquid flows through the discharging port 57 toward an upstream side of the developing roller 41 in the predetermined gap G with respect to the rotational direction. Then, the liquid drips toward the cleaning roller 43 through the predetermined gap G, and falls in the bottom 49 of the casing 40 through the cleaning blade 46.

The liquid developer fell on the bottom 49 of the casing 40 as described above is discharged through a collecting port (opening) 52 formed in the casing 40. As shown in part (a) of FIG. 4, to the collecting port 52, a collecting pipe 54 is connected, and the collecting pipe 54 is, as shown in FIG. 2, connected to the tank 71 through the feeding hose 74. Accordingly, the liquid developer discharged through the collecting port 52 is collected to the tank 71 through the collecting pipe 54 and the feeding hoe 74.

[Non-Uniformity of Flow Rate of Liquid Developer with Respect to Longitudinal Direction]

Here, non-uniformity of a flow rate of the liquid developer in the developer receiving portion with respect to the longitudinal direction will be described using parts (a) and (b) of FIG. 5. Incidentally, the longitudinal direction in the present specification is a widthwise direction crossing the rotational direction of the developing roller 41, specifically is a direction parallel to a rotational axis direction of the developing roller 41. A developing device 400 in a comparison example shown in part (a) of FIG. 5 includes a developer receiving portion 450 different from the constitution shown in part (a) of FIG. 4 described above. Other constitutions are similar to those in part (a) of FIG. 4.

As shown in part (a) of FIG. 5, as regards the developer receiving portion 450, there is no partitioning member in an inside space 450a, and with respect to an inflow direction of the liquid developer, a cross-section area abruptly increases from the receiving port 51 toward the inside space 450a. For this reason, the liquid developer flowing through the receiving port 51 expands so that a main flow is separated from a wall surface of the developer receiving portion 450.

A part of the flow separated from this wall surface generates an eddy circulation region in the neighborhood of an upper portion of the receiving port 51, so that compared with the main flow, a flow speed becomes slow or a direction of the flow changes. For this reason, the flow rate from the receiving port 51 toward the discharging port on the receiving port 51 side decreases. That is, with respect to the longitudinal direction of the developer receiving portion 450, at a portion close to the receiving port 51, the flow rate of the liquid developer flowing toward the discharging port decrease more than at another portion.

In part (b) of FIG. 5, a schematic result in which a longitudinal direction position of the developer receiving portion 450 is taken as an abscissa and in which the flow rate at each position is calculated by simulation is shown. As is apparent from this result, a flow rate distribution of the liquid developer flowing through an inside space 450a of the developer receiving portion 450 is small in flow rate on the receiving port 51 side with respect to the longitudinal direction and has a peak of the flow rate in the neighborhood of a central portion where the main flow reaches.

In such a flow rate distribution of the liquid developer with respect to the longitudinal direction, when an amount of the liquid developer supplied to the developer receiving portion 450 further decreases, a balance with an amount of the liquid developer supplied to the developing roller 41 is destroyed, so that air flows in the gap from a periphery of the film forming electrode 44. When the air flows in the gap, in that region, the liquid developer is not supplied onto the developing roller 41, so that improper coating occurs.

Further, when an amount of the liquid developer supplied to the developer receiving portion 450 is increased in order to prevent this in flow of the air, the flow speed of the liquid developer flowing in the developer receiving portion 450 increases, so that the eddy circulation region separated from the receiving port 51 and then is separated from the main flow further increases. In addition, a flow which is reflected by a side wall of a longitudinal direction end portion of the developer receiving portion 450 opposing the receiving port 51 and which flows back increases, so that a turbulent flow is liable to generate in the inside space 450a. When the turbulent flow generates, a liquid amount of the liquid developer supplied from the developer receiving portion 450 to the developing roller 41 increasingly becomes non-uniform with respect to the longitudinal direction, and an amount of the liquid developer coated on the developing roller 41 does not become uniform, so that density non-uniformity occurs in the formed image in some cases. This problem is liable to occur with an increasing image forming speed and with a decreasing size of the developer receiving portion.

Therefore, in this embodiment, by constituting the developer receiving portion 45 in the following manner, downsizing of the developing device is realized while suppressing the occurrence of the improper coating.

### [Developer Receiving Portion]

The developer receiving portion 45 in this embodiment includes, as shown in FIG. 3 and part (a) of FIG. 4, a partition plate 47 as a partitioning member for partitioning the inside space 45a, filled with the liquid developer supplied through the receiving port 51, into a first chamber 61 on the receiving port side and a second chamber 62 on the discharging port side. The partition plate 47 is disposed along the longitudinal direction (widthwise direction). The partition plate 47 is provided with a plurality communication ports (openings) 50 formed with respect to the longitudinal direction so as to establish communication between the first chamber 61 and the second chamber 62. Incidentally, a total area of the communication ports is smaller than a total area of partitioned regions of the partition plate.

The developer receiving portion 45 is disposed along the longitudinal direction of the developing roller 41 and is formed so that the liquid developer flowing in through the receiving port 51 formed at one longitudinal direction end portion flows toward the discharging port 57 while spreading in the longitudinal direction. Further, the developer receiving portion 45 causes one longitudinal direction end portion side wall 45b thereof and the other longitudinal direction end portion side wall 45c thereof to oppose each other, and forms the inside space 45a between the side walls 45b and 45c.

The partition plate 47 is disposed substantially in parallel to the longitudinal direction and connect the one longitudinal direction end portion side wall 45b and the other longitudinal direction end portion side wall 45c with each other. Further, as described above, the inside space 45a is divided into the first chamber 61 and the second chamber 62. In the case of this embodiment, as shown in FIG. 3, the developing roller 41 is positioned above the developer receiving portion 45, and therefore, the second chamber 62 on the discharging port 57 side is positioned above the first chamber 61. Specifically, the second chamber 62 is positioned obliquely above the first chamber 61 so as to be on the developing roller 41 side. Further, the first chamber 61 and the second chamber 62 have the same length in the longitudinal direction.

The first chamber 61 to which the receiving port 51 is connected has the substantially same cross-sectional shape with respect to the longitudinal direction as an opening shape (a shape as seen from the longitudinal direction) of the receiving port 51. Specifically, the cross-sectional shape of the first chamber 61 perpendicular to the longitudinal direction and the opening shape of the receiving port 51 are substantially circular shapes. That is, as shown in FIG. 6, the receiving port 51 has the opening shape which is the substantially circular shape, and the cross-sectional shape of the first chamber 61 connected to this is the substantially same as a circle of the opening shape of the receiving port 51 or a substantially circular shape slightly larger than this circle. For this reason, a side surface (inside surface) of the partition plate 47 on the first chamber 61 side is the substantially circular shape in cross-section, and a height position (a position with respect to an up-down direction) of the inside surface substantially coincide with a peripheral edge portion of the opening of the receiving port 51 or is positioned somewhat above this peripheral edge portion.

In this embodiment, the side surface of the partition plate 47 on the first chamber 61 side has the substantially circular shape in cross-section over entirety of the longitudinal direction, and the cross-sectional shape of the first chamber 61 is made the same over the longitudinal direction. That is, the first chamber 61 has a tubular shape along the longitudinal direction. On the other hand, the side surface of the partition plate 47 on the second chamber 62 side is a substantially flat surface.

Further, in the case of this embodiment, as shown in FIG. 6, a position (lower end position) A2 of the opening of the communication port 50 on the first chamber 61 side is positioned above a position (upper end position) A1 of an upper end of the receiving port 51. This is because, for example, when the liquid developer is first supplied into the inside space 45a of the developer receiving portion 45, the air also flows into the inside space 45a. In the case where the lower end position A2 of the communication port 50 is the same as or lower than the upper end position A1 of the receiving port 51, the air entered the inside space 45a through the receiving port 51 does not readily pass through the communication port 50 and then through the discharging port 57. For this reason, in this embodiment, the circle of the cross-sectional shape of the first chamber 61 is made slightly larger than the circle of the cross-sectional shape of the receiving port 51, so that the opening of the communication port 50 on the first chamber 61 side is positioned above the upper edge of the receiving port 51.

Incidentally, the cross-sectional shape of the first chamber 61 is made the same over the longitudinal direction in this embodiment, but may also be made different at least at a portion with respect to the longitudinal direction. However, even in this case, the cross-sectional shape of the portion, perpendicular to the longitudinal direction, to which the receiving port 51 is connected at the one longitudinal direction end portions of the first chamber 61 is the substantially same as the opening shape of the receiving port 51. Further, in this case, the cross-sectional shape of the portion to which the receiving port 51 of the first chamber 61 is connected may also be the same as the circle of the opening shape of the receiving port 51 or a substantially circular shape slightly smaller than this circle.

In summary, at a connecting portion of the receiving port 51, it may only be required that a difference in height between the receiving port 51 and the first chamber 61 with respect to a cross-sectional direction can be made small or can be eliminated. As the case where the cross-sectional shape of the first chamber 61 is different at the portion with respect to the longitudinal direction, for example, a constitution in which at a portion with respect to the longitudinal direction, a height position of the inside surface of the partition plate 47 on the first chamber 61 side is located above the connecting portion with the receiving port 51 would be considered. Or, it would be considered that the inside surface of the partition plate 47 is inclined upward toward the other end side with respect to the longitudinal direction.

In this case, the cross-sectional shape of the portion of the first chamber 61 to which the receiving port 51 is connected may also be the same as the circle of the opening shape of the receiving port 51 or the substantially circular shape slightly smaller than this circle. Also, in such a case, at least a portion with respect to the longitudinal direction, the opening of the communication port 50 on the first chamber 61 side is positioned above the upper edge of the receiving port 51, and therefore, the air can be easily caused to pass through the communication port 50. Incidentally, in the case where the height position of the portion of the inside surface of the partition plate 47 on the first chamber 61 side is above another portion, at this portion, at least one communication port 50 may preferably be formed.

Thus, the opening of at least one communication port 50, on the first chamber 61 side, of the plurality of communication ports 50 may only be required to be positioned above the upper edge of the receiving port 51, but at this time, an entire region of the opening of the communication port 50 may also be not positioned above the upper edge of the receiving port 51. For example, in the case where the opening of the communication port 50 is inclined relative to the horizontal direction, when a part of this opening is positioned above the upper edge of the receiving port 51, the air can pass upward through the part of the opening. Accordingly, at least a part of the opening of at least one communication port 50, on the first chamber 61 side, of the plurality of communication ports 50 may only be required to be positioned above the upper edge of the receiving port 51. In other words, the part of the opening of at least one communication port 50 may preferably be positioned at an uppermost edge portion of the first chamber 61. By this, even when the air enters the developer receiving portion 45, the air can be discharged through the communication port 50 with reliability.

Further, the cross-sectional shape of the first chamber 61 perpendicular to the longitudinal direction and the opening shape of the receiving port 51 may also be other shapes such as a polygonal shape and an elliptical shape, in addition to the circular shape. Even in this case, at least the part of the opening of at least one communication port 50, on the first chamber 61 side, of the plurality of communication ports 50 is positioned above the upper edge of the receiving port 51.

Further, in the case of this embodiment, the plurality of communication ports 50 formed in the partition plate 47 are formed so as to penetrate in a direction crossing an inflow direction of the liquid developer flowing in the inside space 45a through the receiving port 51. In this embodiment, the plurality of communication ports 50 are formed with respect to the direction perpendicular to the inflow direction of the liquid developer. Specifically, the developer receiving portion 45 is disposed so that the longitudinal direction thereof is substantially parallel to the horizontal direction, and therefore, the inflow direction of the liquid developer is also the substantially horizontal direction. On the other hand, as shown in FIG. 3 and FIG. 6, the plurality of communication ports 50 are formed so as to penetrate in a direction in which the second chamber 62 is disposed relative to the first chamber 61, i.e., a direction in which the second chamber 62 is inclined relative to the vertical direction so as to be positioned on the developing roller 41 side toward above.

Incidentally, the inflow direction of the liquid developer may be the horizontal direction or may also be the direction inclined relative to the horizontal direction. Further, a penetration direction of the plurality of communication ports 50 may be the vertical direction or may also be a direction inclined relative to the vertical direction. In summary, it may only be required that the inflow direction of the liquid developer and the penetration direction of the communication ports 50 are not parallel to each other.

The thus-formed plurality of communication ports 50 are formed in two columns in parallel to the longitudinal direction, and in each column, the communication ports 50 are equidistantly formed with respect to the longitudinal direction. Further, the cross-sectional shape of each of the communication ports 50 perpendicular to the penetration direction is a circular shape. Here, the number, an interval, a magnitude and a shape of the plurality of communication ports 50 can be appropriately set.

However, the plurality of communication ports 50 are formed so that a flow speed of the liquid developer flowing through the receiving port 51 becomes substantially 0 at the other longitudinal direction end portion (the other widthwise direction end portion). That is, the number of interval, the magnitude, the shape and the like of the plurality of communication ports 50 are set so that the flow speed of the liquid developer in the first chamber 61 becomes substantially 0 in the neighborhood of the side wall 45c of the developer receiving portion 45 at the other longitudinal direction end portion.

Incidentally, the flow of the liquid developer in the first chamber 61 is disturbed by the cross-sectional shape of the first chamber 61 or the like in some instances, and therefore, the number and the like of the plurality of communication ports 50 may preferably be set appropriately in consideration of this disturbance or the like.

The second chamber 62 is a flow passage between the first chamber 61 and the discharging port 57 and guides the liquid developer, to the discharging port 57, caused to flow in the second chamber 62 through the plurality of communication ports 50. The discharging port 57 opens to the predetermined gap G. In this embodiment, the discharging port 57 is disposed obliquely below a center of the developing roller 41, and through which the liquid developer sent to the second chamber 62 is discharged toward the predetermined gap G.

Further, the second chamber 62 includes as shown in FIG. 3 and FIG. 6, a drawing portion 63 formed so that the flow passage along which the liquid developer flows narrows toward the discharging port 57. As described above, in this embodiment, the inside space 45a is formed between the side wall 45b and the side wall 45c by causing the one longitudinal direction end portion side wall 45b and the other longitudinal direction end portion side wall 45c of the developer receiving portion 45 to oppose each other. For this reason, the first chamber 61 and the second chamber 62 have the same length, in the longitudinal direction, of the flow passage from the first chamber 61 toward the discharging port 57 through the second chamber 62. Accordingly, the drawing portion 63 is formed so that an interval of the flow passage with respect to a direction perpendicular to the longitudinal direction, i.e., an interval between side walls 63a and 63b gradually becomes narrows toward the discharging port 57.

Further, on a further discharging port 57 side of the drawing portion 63 of the second chamber 62, a flow passage 64 in which an interval thereof with respect to the direction perpendicular to the longitudinal direction, i.e., the interval between the side walls 64a and 64b opposing each other with respect to this direction is unchanged over the flowing direction is formed. Accordingly, the liquid developer flowing from the first chamber 61 to the second chamber 62 through the plurality of communication ports 50 of the partition plate 47 reaches the discharging port 57 through the drawing portion 63 and the flow passage 64.

Incidentally, the discharging port 57 is positioned at an uppermost portion in the second chamber 62. This is because as described above, in the case where the air flowing in the first chamber 61 passes through the communication ports 50 and is sent to the second chamber 62, the air is easily discharged to an outside through the discharging port 57 and the predetermined gap G.

In the thus-constituted developing device 4 in this embodiment, the liquid developer fed from the external tank 71 by using the supplying pump 75 is sent into the first chamber 61 of the developer receiving portion 45 from the receiving port 51 through the feeding hose 74 and the supplying pipe 53. The liquid developer sent to the first chamber 61 passes through the plurality of communication ports 50 provided in the partition plate 47 and is sent to the second chamber 62 of the developer receiving portion 45. The liquid developer sent to the second chamber 62 reaches the discharging port 57 through the drawing portion 63 and the flow passage 64 and is scooped into the predetermined gap G between the developing roller 41 and the film forming electrode 44 by rotation of the developing roller 41.

Here, a speed (flow speed) of the liquid developer passing through the supplying pipe 53 varies depending on an image forming process speed and a pipe diameter of the supplying pipe 53, but is roughly about 1-3 m/sec which is a considerably high speed. However, the flow speed of the liquid developer flowing from the supplying pipe 53 into the first chamber 63 of the developer receiving portion 45 becomes slow, as shown by arrows in part (a) of FIG. 4, with an increasing distance from the receiving port 51 in the first chamber 61. Then, the flow speed is adjusted so as to approach zero in the neighborhood (at the other longitudinal direction end portions of the first chamber 61) of the side wall 45c opposite from the receiving port 51. That is, the plurality of communication ports 50 are formed in the partition plate 47 so as to provide such a flow speed. Incidentally, the arrows shown in part (a) of FIG. 4 represent flow speeds by their lengths, and show that the flow speed is slower with a shorter length.

Further, in this embodiment, the first chamber 61 has the cross-sectional shape which is the same over the longitudinal direction, and the other longitudinal direction end portion is blocked, and therefore, inside pressure of the first chamber 61 becomes substantially constant. For that reason, as shown by the arrows in part (a) of FIG. 4, the liquid developer having the same flow speed is sent into the second chamber 62 through the plurality of communication ports 50 provided in the partition plate 47.

By this, as shown in part (b) of FIG. 4, the liquid developer sent from the first chamber 61 to the second chamber 62 of the developer receiving portion 45 in an entire region of the longitudinal direction has a substantially uniform flow rate distribution. That is, the partition plate 47 is provided in the inside space 45a of the developer receiving portion 45, and in this partition plate 47, the plurality of communication ports 50 are formed with respect to the longitudinal direction, so that the flow of the liquid developer flowing from the receiving port 51 to the discharging port 57 can be rectified.

Thus, in this embodiment, not only the inside space 45a of the developer receiving portion 45 is partitioned by the partition plate 47 but also the plurality of communication ports 50 are formed with respect to the longitudinal direction in the partition plate 47, and therefore, the flow rate distribution of the liquid developer, with respect to the longitudinal direction, supplied to the predetermined gap G does not readily become non-uniform. For this reason, it is possible to suppress improper coating onto the developing roller 41 due to non-uniformity in flow rate distribution.

Further, in the case of this embodiment, such uniformization (rectification) of the flow rate distribution of the liquid developer with respect to the longitudinal direction can be carried out without lengthening the flow passage from the receiving port 51 toward the discharging port 57 by providing the plurality of communication ports 50 in the partition plate 47. For this reason, it is possible to avoid upsizing of the developer receiving portion 45, so that downsizing of the photosensitive drum 4 can be realized. That is, according to the constitution of this embodiment, the downsizing of the discharging port is realized while suppressing the improper coating.

Incidentally, as described above, it is possible to perform rectification also by providing the drawing portion 63 in the second chamber 62. That is, in this embodiment, the rectification is performed in two stages of the plurality of communication ports 50 of the partition plate 47 and the drawing portion 63. By this, the flow rate distribution of the liquid developer, with respect to the longitudinal direction, supplied to the predetermined gap G can be further uniformized. However, this drawing portion 63 is omitted, so that further downsizing of the developer receiving portion 45 may also be realized.

Further, in the case of this embodiment, the second chamber 62 is positioned above the first chamber 61, and therefore, the air flowing in the first chamber 61 passes through the communication ports 50 and then passes through the second chamber 62, and is liable to be discharged to the outside through the discharging port 57. For this reason, it is possible to suppress that the air remains on the inside space 45a of the developer receiving portion 45.

By disposing the second chamber 62 above the first chamber 61, the shape of the developer receiving portion 45 can be made long with respect to the up-down direction, and a width of the developer receiving portion 45 with respect to the horizontal direction can be made small. For this reason, as in this embodiment, in the case where the developing device 4 is incorporated in the image forming apparatus 100 of a tandem type in which a plurality of image forming portions are disposed along the rotational direction of the intermediary transfer belt 7, a pitch between the image forming portions can be narrowed, so that downsizing of the image forming apparatus can be realized.

### Second Embodiment

A second embodiment will be described using parts (a) and (b) of FIG. 7. In the above-described first embodiment, the height position of the inside surfaces of the partition plate 47 on the first chamber 61 side was caused to coincide with the position of the peripheral edge portion of the opening of the receiving port 51. On the other hand, in the case of a photosensitive drum 4A in this embodiment, a height position of a partition plate 47A was above a peripheral edge portion of an opening of a receiving port 51 as shown in part (a) of FIG. 7.

In the case of such this embodiment, as shown by arrows in part (a) of FIG. 7, when the liquid developer flows in the first chamber 61 through the receiving port 51, due to a difference in height between the receiving port 51 and the partition plate 47, an eddy circulation region separated from the main flow generates near a side wall 45b. By the influence of this circulation region, the flow of the liquid developer on the receiving port 51 side with respect to the longitudinal direction is disturbed, so that the flow rate of the liquid developer sent to the second chamber 62 decreases.

Then, as shown in part (b) of FIG. 7, at a position of the developer receiving portion 45A with respect to the longitudinal direction, the flow rate of the liquid developer becomes small on the receiving port 51 side, and further, the flowing direction of the main flow of the liquid developer is inclined, and therefore, a turbulent flow generates also in the neighborhood of the side wall 45c side opposite from the receiving port 51 and the flow rate decreases. Further, in the case of this embodiment, the flow rate distribution of the liquid developer with respect to the longitudinal direction can be stabilized than in the comparison example shown in part (a) of FIG. 5. That is, in the case of the comparison example shown in part (a) of FIG. 5, there is no partition plate and therefore, as shown in part (b) of FIG. 5, a change in flow rate distribution of the liquid developer with respect to the longitudinal direction is large. On the other hand, in the case of this embodiment, as shown in part (b) of FIG. 7, the change in flow rate distribution of the liquid developer with respect to the longitudinal direction can be made small than in the comparison example. For this reason, the flow rate distribution of the liquid developer with respect to the longitudinal direction can be uniformized than in the comparison example, so that an occurrence of improper coating can be suppressed.

Further, in the case of this embodiment, the partition plate 47A is provided sufficiently above the receiving port 51, and therefore, the air flowing in the first chamber 61 can be discharged with high reliability through the communication ports 50 formed in the partition plate 47A. Other constitutions and functions are similar to those in the first embodiment.

### INDUSTRIAL APPLICABILITY

Accordingly to the present invention, there is provided the developing device which is the developing device for the electrophotographic image forming apparatus or the like and which is downsized while suppressing the generation of the improper coating.

The present invention is not limited to the above-described embodiments, but can be variously changed and modified without departing from the spirit and the scope of the present invention. Accordingly, the following claims are attached for making the scope of the present invention public.

The present application claims priority on the basis of Japanese Patent Application No. 2018-049640 filed on Mar. 16, 2018, which is hereby incorporated by reference herein in its entirety.

1. A developing device comprising:
a developer carrying member rotatable while carrying liquid developer containing toner and a carrier;
an accommodating member which includes a receiving port for receiving the liquid developer and a supplying port for supplying the received liquid developer to said developer carrying member and which accommodates the liquid developer; and
a partitioning member extending over a rotational axis direction of said developer carrying member and partitioning an inside space of said accommodating member into a first chamber including said receiving port and a second chamber including said supplying port,
wherein in said partitioning member, a plurality of communication ports for communicating between said first chamber and said second chamber are formed over the rotational axis direction of said developer carrying member.

2. A developing device according to claim 1, wherein said communication ports are formed so as to penetrate in a direction crossing an inflow direction of the liquid developer flowing therein through said receiving port.

3. A developing device according to claim 1, wherein said plurality of communication ports are positioned above an upper end edge of said receiving port with respect to a vertical direction.

4. A developing device according to claim 1, wherein said receiving port is formed at one end portion of said first chamber with respect to a rotational axis direction.

5. A developing device according to claim 4, wherein an inflow direction of the liquid developer flowing through said receiving port is substantially parallel to said rotational axis direction.

6. A developing device according to claim 1, wherein said receiving port is provided in a surface of said accommodating portion.

7. A developing device according to claim 6, wherein a cross-sectional shape of said first chamber perpendicular to said widthwise direction at a portion which is one end portion of said first chamber with respect to said widthwise direction and to which said receiving port is connected is substantially the same as a shape of said receiving port.

8. A developing device according to claim 1, wherein said partitioning member is provided substantially in parallel to said rotational axis direction.

9. A developing device according to claim 1, wherein a total area of said communication ports is smaller than a total area of a partition region of said partitioning portion.

10. A developing device according to claim 1, wherein said supplying port is provided above said receiving port with respect to a vertical direction.

11. A developing device according to claim 1, wherein on a side downstream of said supplying port with respect to a rotational direction of said developer carrying member, an electrode portion for generating a potential difference between itself and an electrostatic latent image is provided.

12. A developing device according to claim 11, wherein with respect to the rotational direction of said developer carrying member, a side upstream of a developing portion for developing the electrostatic latent image, formed on an image bearing member, by said developer carrying member and downstream of said electrode portion, a roller contacting said developer carrying member is provided.
